(19) United States
(12) Patent Application Publication
(10) Pub. No.: US 2020/0011233 A1
(43) Pub. Date: Jan. 9, 2020

(54) ELECTRIC SUPERCHARGER

(71) Applicant: KABUSHIKI KAISHA TOYOTA JIDOSHOKKI, Aichi-ken (JP)

(72) Inventor: Makio OSHITA, Aichi (JP)

(73) Assignee: KABUSHIKI KAISHA TOYOTA JIDOSHOKKI, Aichi-ken (JP)

(21) Appl. No.: 16/457,051

(22) Filed: Jun. 28, 2019

(30) Foreign Application Priority Data
Jul. 5, 2018 (JP) 2018-127963

(51) Int. Cl. F02B 39/10; F02B 33/40; F04D 29/059; F04D 29/063

(52) U.S. Cl. CPC F02B 39/10; F04D 29/063; F04D 29/059; F02B 33/40

(57) ABSTRACT

An electric supercharger includes a rotary shaft, a motor, a motor housing, a sealing plate, an impeller, a rolling bearing, and an oil injection portion. The rotary shaft extends in an axial direction thereof. The motor rotationally drives the rotary shaft. The motor housing accommodates the motor and has an opening. The sealing plate seals the opening. The impeller is fixed to the rotary shaft. The rolling bearing is disposed in the sealing plate or adjacent thereto. The oil injection portion injects lubrication oil to the rolling bearing. In the sealing plate, an oil discharge space is formed adjacent to the rolling bearing and a deflector portion protruded radially inward is formed over at least in part in a circumferential direction of the rotary shaft.

### CROSS-REFERENCE TO RELATED APPLICATION

This application claims priority to Japanese Patent Application No. 2018-127963 filed on Jul. 5, 2018, the entire disclosure of which is incorporated herein by reference.

### BACKGROUND ART

The present disclosure relates to an electric supercharger performing supercharge by using a motor rotationally driving a rotary shaft to which an impeller is attached.

Japanese Patent Application Publication No. 2017-210879 discloses an electric supercharger including rolling bearings in opposite ends of a motor housing. The rolling bearings rotatably support a rotary shaft to which an impeller is attached. To prevent seizure of the rolling bearings, oil supply members through which lubrication oil is supplied to the rolling bearings are provided. The oil supply members, which are disposed in the motor housing, inject lubrication oil to the rolling bearings. This injection makes sure to spread the lubrication oil all over inside the rolling bearing, thereby preventing seizure of the rolling bearings.

In the electric supercharger according to Japanese Patent Application Publication No. 2017-210879, the oil supply members face the rolling bearings, and lubrication oil is injected from the oil supply members to the rolling bearings. Much of the lubrication oil is discharged from a furthest side of the rolling bearing from the oil supply members. With respect to the rolling bearing located near an impeller, it is possible that the configuration of the Publication No. 2017-210879 causes the lubrication oil discharged from the rolling bearing to flow out over a sealing plate toward the impeller (to an impeller side). One idea to prevent such a flowing out of the lubrication oil is to provide a deflector in a manner described in Japanese Patent Application Publication No. H07-217440. However, if a deflector is newly provided between the rolling bearing and the impeller, the distance between the impeller and the rolling bearing supporting the rotary shaft in an axial direction of the rotary shaft increases in length, thereby causing harder whirling or vibration of the impeller.

The present disclosure has been made in view of the above circumstances and is directed to providing an electric supercharger in which lubrication oil is injected to rolling bearings rotatably supporting a rotary shaft, to prevent flowing out of lubrication oil to the impeller side with no increase in vibration of the impeller.

### SUMMARY

In accordance with an aspect of the present disclosure, there is provided an electric supercharger that includes a rotary shaft, a motor, a motor housing, a sealing plate, an impeller, a rolling bearing, and an oil injection portion. The rotary shaft extends in an axial direction of the rotary shaft. The motor rotationally drives the rotary shaft. The motor housing accommodates the motor and has on a first end side thereof in the axial direction of the rotary shaft an opening for putting in and out the motor. The sealing plate seals the opening. The impeller is fixed to the rotary shaft at a position closer to the first end side than the sealing plate is to the first end side. The rolling bearing is disposed in the sealing plate or adjacent to the sealing plate on the second end side in the axial direction of the rotary shaft. The rolling bearing is configured to rotatably support the rotary shaft. The oil injection portion injects lubrication oil to the rolling bearing from a second end side in the axial direction of the rotary shaft and away from the rolling bearing. An oil discharge space is formed adjacent to the rolling bearing on the first end side and communicated with a space between an outer ring and an inner ring of the rolling bearing in the sealing plate. A deflector portion protruded radially inward is formed at a position away on the first end side from the rolling bearing across the oil discharge space, over at least in part in a circumferential direction of the rotary shaft in the sealing plate.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of an electric supercharger according to an embodiment of the present disclosure;

FIG. 2 is an enlarged partial cross-sectional view of an area A in FIG. 1 according to the embodiment of the present disclosure;

FIG. 3A is a front view of a sealing plate according to the embodiment of the present disclosure; and

FIG. 3B is a cross-sectional view of the sealing plate according to the embodiment of the present disclosure.

### DETAILED DESCRIPTION OF THE EMBODIMENTS

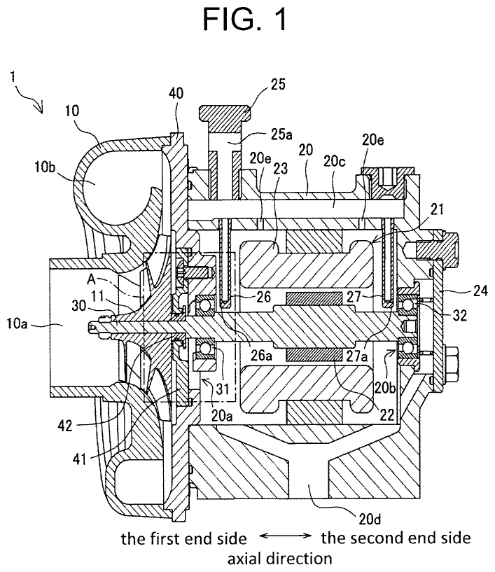

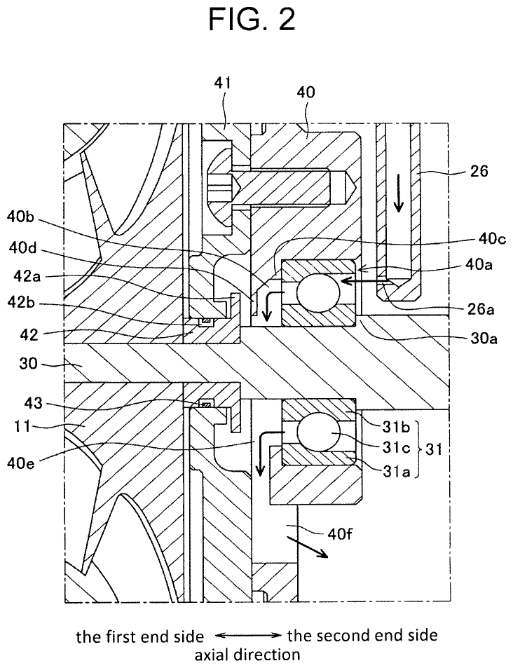

The following will describe an electric supercharger according to an embodiment of the present disclosure with reference to the accompanying drawings. FIG. 1 is a cross-sectional view of an electric supercharger 1 according to the embodiment of the present disclosure, and FIG. 2 is a partial cross-sectional view enlarging an area A in FIG. 1. The electric supercharger 1, for example, an apparatus to compress an amount of intake air (air) supplied to an engine, is mounted in an engine compartment. The vertical direction in the electric supercharger 1 coincides with upper and lower directions in FIG. 1.

The electric supercharger 1 is configured such that a motor 21 accommodated in a motor housing 20 rotationally drives a rotary shaft 30 and an impeller 11 accommodated in a compressor housing 10. The impeller 11 is attached to one end of the rotary shaft 30 extending in an axial direction of the rotary shaft 30. A first rolling bearing 31 and a second rolling bearing 32 rotatably support the rotary shaft 30. The first rolling bearing 31 and the second rolling bearing 32 correspond to a rolling bearing of the present disclosure. The first rolling bearing 31 is disposed in one end side of the rotary shaft 30 in the axial direction thereof (a left side in FIG. 1, hereinafter simply called the first end side), and the second rolling bearing 32 is disposed in the other end side of the rotary shaft 30 in the axial direction thereof (a right side in FIG. 1, hereinafter simply called the second end side). The one end side and the other end side correspond to the first end side and the second end side, respectively. The impeller 11 is fixed to the rotary shaft 30 at a position closer to the first end side than a sealing plate 40 including the first rolling bearing 31 is to the first end side.

The motor 21 includes a rotor 22 and a stator 23. The rotor 22 is fixed to the rotary shaft 30 between the first rolling bearing 31 and the second rolling bearing 32. The stator 23 is disposed radially outward of the rotor 22 and fixed in the motor housing 20. When an electric current is supplied to a coil wound around the stator 23, torque is generated at the rotor 22 to rotate the rotary shaft 30, thereby rotationally driving the impeller 11. Electric power is supplied from, for example, a battery mounted in a vehicle (not shown) to the stator 23.

The compressor housing 10 includes an intake passage 10a through which an amount of intake air is suctioned into the compressor housing 10 and a discharge passage 10b through which an amount of intake air compressed by the impeller 11 is discharged. The compressor housing 10 includes at the rear side of the impeller 11 a member which is configured by the sealing plate 40. The rotating of the impeller 11 by the driving of the motor 21 compresses the intake air suctioned through the intake passage 10a, and then the compressed intake air is supplied to the engine through the discharge passage 10b.

The motor housing 20 is formed nearly in a bottomed cylindrical shape. A first opening 20a for putting in and out the motor 21 is formed in an end surface of the motor housing 20 on the first end side thereof in the axial direction of the rotary shaft 30. The first opening 20a corresponds to an opening of the present disclosure. The sealing plate 40 seals the first opening 20a. The motor housing 20 has in an end surface thereof on the second end side a second opening 20b in which the second rolling bearing 32 is disposed. A cover 24 covers the second opening 20b.

The motor housing 20 is configured to supply lubrication oil to the first rolling bearing 31 and the second rolling bearing 32. An oil introducing member 25 having an oil introducing passage 25a is attached to an upper part of the motor housing 20. The oil introducing passage 25a is connected to an oil supply passage 20c formed in the motor housing 20. The oil supply passage 20c is formed to extend in the axial direction in the upper part of the motor housing 20. A first oil supply member 26 extends radially inward from the oil supply passage 20c and has a pipe-like shape. The first oil supply member 26 is attached to an end of the oil supply passage 20c on the first end side in the motor housing 20. This configuration connects an inner passage formed inside the pipe-like first oil supply member 26 to the oil supply passage 20c. Furthermore, a second oil supply member 27 extends radially inward from the oil supply passage 20c and has a pipe-like shape. The second oil supply member 27 is attached to an end of the oil supply passage 20c on the second end side in the motor housing 20. This configuration connects an inner passage formed inside the pipe-like second oil supply member 27 to the oil supply passage 20c.

As shown in FIG. 2, the first oil supply member 26 has an injection port 26a corresponding to an oil injection portion of the present disclosure, at a position facing a space between an outer ring 31a and an inner ring 31b of the first rolling bearing 31 (an space in which a rolling element 31c is arranged). Lubrication oil that is supplied to the oil supply passage 20c via the oil introducing member 25 flows through the inner passage of the pipe-like first oil supply member 26 to the injection port 26a, and is injected into the first rolling bearing 31. Then the lubrication oil spreads all over inside the first rolling bearing 31 (the space between the outer ring 31a and the inner ring 31b) with a rotation of the rotary shaft 30, thereby preventing seizure of the first rolling bearing 31. Similar to the configuration described above, the second oil supply member 27 has an injection port 27a at a position facing an space between an outer ring and an inner ring of the second rolling bearing 32 (an space in which a rolling element is arranged). Lubrication oil injected from the injection port 27a to the space prevents seizure of the second rolling bearing 32.

Referring back to FIG. 1, the motor housing 20 has at a position facing a coil end of the stator 23 an oil passage 20e extending radially inward from the oil supply passage 20c. With this configuration, some lubrication oil supplied via the oil introducing member 25 to the oil supply passage 20c flows through the oil 20 passage 20e to the coil end of the stator 23 in the motor 21, and then directly cools the coil end. The motor housing 20 has in a lower part thereof an oil discharge passage 20d. The lubrication oil injected from the first oil supply member 26 to the first rolling bearing 31, the lubrication oil injected from the second oil supply member 27 to the second rolling bearing 32, and the lubrication oil supplied from the oil passage 20e to the motor 21 flow down to the bottom of the motor housing 20 and finally flow out of the motor housing 20 through the oil discharge passage 20d.

The sealing plate 40 is formed in a disk-like shape and fixed to the motor housing 20. The sealing plate 40 serves a function not only to seal the first opening 20a of the motor housing 20 but also to form the rear face of the compressor housing 10. The sealing plate 40 will be described in detail later.

A seal retainer 41 and a sealing collar 42 are disposed between the sealing plate 40 and the impeller 11 and cooperate to form the labyrinth seal to prevent lubrication oil supplied to the first rolling bearing 31 from flowing out over the surface of the sealing plate 40 on the first end side (hereinafter simply called as in an impeller 11 side). The seal retainer 41 is fixed to the surface of the sealing plate 40 on the first end side. The sealing collar 42 is arranged radially inward of the seal retainer 41. The sealing collar 42 is mounted to the rotary shaft 30 and integrally rotates with the rotary shaft 30.

As shown in FIG. 2, a seal portion 42a protruding radially outward is formed in the end of the sealing collar 42 on the second end side. The sealing collar 42 has in the outer peripheral surface thereof an annular groove 42b in which a seal ring 43 is fitted. The seal ring 43 is a C-shaped sealing member and is in contact with the inner peripheral surface of the seal retainer 41. Thus, when the seal portion 42a and the seal ring 43 are provided in the sealing collar 42, protrusions and recesses are formed on the boundary surface between the seal retainer 41 and the sealing collar 42, serving as the labyrinth seal.

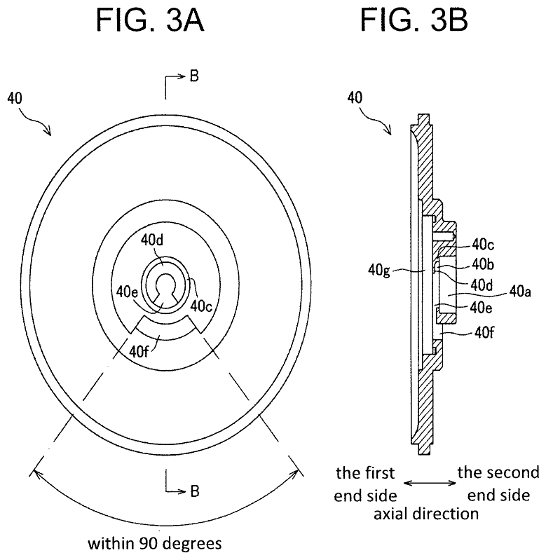

The details of the sealing plate 40 will be described below. FIGS. 3A and 3B are a front view and a cross-sectional view of the sealing plate 40, respectively. In more detail, FIG. 3A is a front view of the sealing plate 40 as viewed from the second end side, and FIG. 3B is a cross-sectional view taken along line B-B of FIG. 3A. A holding space 40a, an oil discharge space 40b, a contact portion 40c, a deflector portion 40d, an open area 40e, and a discharge port 40f are formed in the second end side of the sealing plate 40. An accommodation space 40g for accommodating the seal retainer 41 and the sealing collar 42 is formed in the first end side of the sealing plate 40.

The holding space 40a is configured to accommodate and hold the first rolling bearing 31 inside, and formed in a central part of the sealing plate 40 on the second end side. The oil discharge space 40b is formed in an annular shape adjacent to the holding space 40a (or the first rolling bearing 31) on the first end side and communicated with the space between the outer ring 31a and the inner ring 31b of the first rolling bearing 31 (see FIG. 2). Therefore, when the injection port 26a injects lubrication oil to the first rolling bearing 31 from the second end side in the axial direction of the rotary shaft 30 and away from the first rolling bearing 31, much of the lubrication oil is discharged to the oil discharge space 40b.

The contact portion 40c defines the oil discharge space 40b radially outward and is in contact with the end surface on the first end side of the outer ring 31a of the first rolling bearing 31 disposed in the holding space 40a. As shown in FIG. 2, the first rolling bearing 31 is positioned to be held between the contact portion 40c and a step 30a formed in the rotary shaft 30.

The deflector portion 40d is formed at a position away on the first end side from the first rolling bearing 31 across the oil discharge space 40b and protruded radially inward from the contact portion 40c in the sealing plate 40. As shown in FIG. 2, the deflector portion 40d partially overlaps with the seal portion 42a of the sealing collar 42 as viewed in the axial direction. This configuration also forms the labyrinth seal, similar to the seal retainer 41 and the sealing collar 42.

As shown in FIG. 3A, the deflector portion 40d is not formed over the whole circumference in a circumferential direction of the rotary shaft 30 (hereinafter, simply called as a circumferential direction), that is, the deflector portion 40d is partially formed in the circumferential direction. In more detail, a partial area which is the void including the lowermost part of the deflector portion 40d in the circumferential direction does not have the deflector portion 40d. This partial area serves as the open area 40e through which lubrication oil flows. The open area 40e is formed within 90 degrees in the circumferential direction. The discharge port 40f is formed below the open area 40e in an arc shape within almost the same range as the open area 40e in the circumferential direction. The discharge port 40f penetrates through the sealing plate 40 in the axial direction.

As indicated by arrows in FIG. 2, much lubrication oil injected from the first oil supply member 26 to the first rolling bearing 31, flows through the oil discharge space 40b, the open area 40e, and the discharge port 40f to an inner space of the motor housing 20, and is finally discharged through the oil discharge passage 20d (see FIG. 1) formed in the lower part of the motor housing 20.

Lubrication oil does not remain in the first rolling bearing 31 with such a configuration in which lubrication oil is constantly supplied to and discharged from the first rolling bearing 31, so that an increase in rolling resistance generated in the first rolling bearing 31 is restricted. Although there is a type of rolling bearings in which lubrication oil is sealed in the rolling bearing in advance, the lubrication oil is degraded with long-term use. On the other hand, the configuration of the present embodiment restricts the degradation of lubrication oil.

Therefore, the electric supercharger 1 has durability for long-term use.

### Advantageous Effects

According to the electric supercharger 1 of the present embodiment, the oil discharge space 40b and the deflector portion 40d are formed in the sealing plate 40. The oil discharge space 40b communicating with the space between the outer ring 31a and the inner ring 31b of the first rolling bearing 31 is formed adjacent to the first rolling bearing 31 on the first end side. The deflector portion 40d protruded radially inward from the contact portion 40c is formed at a position away on the first end side from the first rolling bearing 31 across the oil discharge space 40b, over at least in part in the circumferential direction of the rotary shaft 30. With this configuration, much of lubrication oil injected to the first rolling bearing 31 is discharged through the oil discharge space 40b formed in the sealing plate 40. The deflector portion 40d is formed at a position away on the first end side from the first rolling bearing 31 across the oil discharge space 40b in the sealing plate 40, thereby preventing flowing out of lubrication oil from the oil discharge space 40b to the impeller 11 side. The sealing plate 40 is conventionally mounted in an electric supercharger to seal the motor housing 20. Unlike the case of newly forming a deflector as a separate member from the sealing plate 40, the deflector portion 40d formed in the sealing plate 40 restricts the distance between the impeller 11 and the first rolling bearing 31 in the axial direction to be longer. Therefore, the electric supercharger 1 prevents the lubrication oil from flowing out to the impeller 11 side without increasing in vibration of the impeller 11.

In the present embodiment, the deflector portion 40d protrudes radially inward to a position overlapping with the inner ring 31b of the first rolling bearing 31 as viewed in the axial direction. Much of lubrication oil injected to the first rolling bearing 31 is discharged to the oil discharge space 40b through the space between the outer ring 31a and the inner ring 31b. Therefore, this overlapping of the deflector portion 40d with the inner ring 31b covers the space between the outer ring 31a and the inner ring 31b, thereby further effectively preventing the flowing out of the lubrication oil to the impeller 11 side.

In the present embodiment, the deflector portion 40d is not formed in the open area 40e including the lowermost part of the deflector portion 40d in the circumferential direction. The lubrication oil in the oil discharge space 40b is discharged through the open area 40e. This configuration smoothly discharges the lubrication oil in the oil discharge space 40b through the open area 40e, that is, easily discharges the lubrication oil from the first rolling bearing 31 to restrict an increase in rolling resistance caused by the remaining of the lubrication oil in the first rolling bearing 31.

In the present embodiment, the open area 40e is formed within 90 degrees in the circumferential direction. Although the larger open area 40e that does not form the deflector portion 40d smoothly discharges the lubrication oil in the oil discharge space 40b, the lubrication oil easily flows to the impeller 11 side. Forming the open area 40e within 90 degrees achieves both smooth discharge of lubrication oil and prevention of the flowing out of lubrication oil to the impeller 11.

In the present embodiment, the sealing collar 42 is mounted to the rotary shaft 30 and has the seal portion 42a protruding radially outward between the impeller 11 and the sealing plate 40. The deflector portion 40d and the seal portion 42a at least in part overlap with each other as viewed in the axial direction. This overlapping of the deflector portion 40d with the seal portion 42a configures the labyrinth seal, thereby effectively preventing the following out of the lubrication oil to the impeller 11 side.

In the present embodiment, the sealing plate 40 has a holding space 40a configured to hold the first rolling bearing 31. The holding space 40a is located adjacent to the oil discharge space 40b on the second end side in the axial direction. This configuration holds the first rolling bearing 31 in the sealing plate 40, so that it is not required to provide a separate member from the first rolling bearing 31 to hold the first rolling bearing 31. Therefore, this configuration reduces the number of parts to have advantages in cost and the number of assembly steps. In addition, this configuration shortens the distance between the impeller 11 and the first rolling bearing 31 in the axial direction to restrict the vibration of the impeller 11 effectively.

In the present embodiment, the sealing plate 40 doubles as the member forming a rear face of a compressor housing 10 accommodating the impeller 11 on the second end side in the axial direction. This usage of the sealing plate 40 reduces the number of parts to have advantages in cost and assembly steps. In addition, this configuration shortens the distance between the impeller 11 and the first rolling bearing 31 in the axial direction to restrict the vibration of the impeller 11 effectively.

### Other Embodiments

The following will describe the modifications which add various changes to the above embodiment.

In the above embodiment, the deflector portion 40d has in the circumferential direction the void portion, and the void open area 40e configures a part of the discharge path. However, a deflector portion may be formed over the whole circumference in the circumferential direction and have a through hole which configures a part of the discharge path near the lowermost part of the deflector portion.

Although the open area 40e is formed within 90 degrees in the circumferential direction in the above embodiment, the open area 40e may be formed over 90 degrees.

In the above embodiment, the discharge port 40f is formed in the sealing plate 40, and within almost the same range as the open area 40e in the circumferential direction. However, the discharge port 40f need not necessarily be formed within substantially the same range as the open area 40e.

In the above embodiment, the deflector portion 40d is configured to overlap the inner ring 31b of the first rolling bearing 31 and the seal portion 42a of the sealing collar 42 as viewed in the axial direction. However, the deflector portion 40d need not necessarily have such a configuration. The space between the outer ring 31a and the inner ring 31b of the first rolling bearing 31 may be covered at least in part by the deflector portion 40d.

In the above embodiment, the first rolling bearing 31 is disposed in the holding space 40a formed in the sealing plate 40, namely, in the sealing plate 40. However, the first rolling bearing 31 need not necessarily be disposed in the sealing plate 40, and the first rolling bearing 31 may be disposed adjacent to the sealing plate 40 on the second end side in the axial direction of the rotary shaft 30.

Although the sealing plate 40 doubles as a member to configure the rear face of the compressor housing 10 in the above embodiment, the sealing plate 40 need not necessarily have such a configuration.

In the above embodiment, the first oil supply member 26 and the second oil supply member 27 are provided as the separate members from the motor housing 20, and lubrication oil is injected from the injection port 26a and 27a formed in the first oil supply member 26 and the second oil supply member 27 to the first rolling bearing 31 and the second rolling bearing 32. However, the present disclosure is not limited to such a configuration, and, for example, the motor housing 20 may have oil passages having injection ports from which the lubrication oil is injected to the first rolling bearing 31 and the second rolling bearing 32.

What is claimed is:

1. An electric supercharger comprising:
a rotary shaft extending in an axial direction of the rotary shaft;
a motor rotationally driving the rotary shaft;
a motor housing accommodating the motor and having on a first end side thereof in the axial direction of the rotary shaft an opening for putting in and out the motor;
a sealing plate sealing the opening;
an impeller fixed to the rotary shaft at a position closer to the first end side than the sealing plate is to the first end side;
a rolling bearing disposed in the sealing plate or adjacent to the sealing plate on a second end side in the axial direction of the rotary shaft, the rolling bearing being configured to rotatably support the rotary shaft; and
an oil injection portion injecting lubrication oil to the rolling bearing from the second end side in the axial direction of the rotary shaft and away from the rolling bearing, wherein
an oil discharge space is formed adjacent to the rolling bearing on the first end side and communicated with a space between an outer ring and an inner ring of the rolling bearing in the sealing plate, and
a deflector portion protruded radially inward is formed at a position away on the first end side from the rolling bearing across the oil discharge space, over at least in part in a circumferential direction of the rotary shaft in the sealing plate.

2. The electric supercharger according to claim 1, wherein
the deflector portion protrudes radially inward to a position overlapping with the inner ring of the rolling bearing as viewed in the axial direction.

3. The electric supercharger according to claim 1, wherein
the deflector portion is not formed in an open area including a lowermost part of the deflector portion in the circumferential direction, and the lubrication oil in the oil discharge space is discharged through the open area.

4. The electric supercharger according to claim 1, wherein
the open area is formed within 90 degrees in the circumferential direction.

5. The electric supercharger according to claim 1, wherein
a sealing collar is mounted to the rotary shaft and has a seal portion protruding radially outward between the impeller and the sealing plate, and
the deflector portion and the seal portion at least in part overlap with each other as viewed in the axial direction.

6. The electric supercharger according to claim 1, wherein
the sealing plate has a holding space configured to hold the rolling bearing, the holding space being located adjacent to the oil discharge space on the second end side in the axial direction.

7. The electric supercharger according to claim 1, wherein
the sealing plate doubles as a member forming a rear face of a compressor housing accommodating the impeller on the second end side in the axial direction.
